(19) United States
(12) Patent Application Publication
(10) Pub. No.: US 2019/0079316 A1
(43) Pub. Date: Mar. 14, 2019

(54) CONNECTED OPTICAL ELEMENT

(71) Applicant: Essilor International, Charenton le Pont (FR)

(72) Inventors: Jerome BALLET, Charenton le Pont Cedex (FR); Samuel ARCHAMBEAU, Charenton le Pont Cedex (FR); Jean-Paul CANO, Charenton le Pont Cedex (FR); Stephane PERROT, Charenton le Pont Cedex (FR)

(73) Assignee: Essilor International, Charenton le Pont (FR)

(21) Appl. No.: 15/743,038

(22) PCT Filed: Jul. 5, 2016
(86) PCT No.: PCT/FR2016/051697

§ 371 Date: Jan. 9, 2018

(30) Foreign Application Priority Data
Jul. 10, 2015 (EP) 15306149.4

(51) Int. Cl. G02C 7/08; G02C 7/02

(52) U.S. Cl. CPC G02C 7/083; G02C 7/027

(57) ABSTRACT

The invention relates to a method for connecting an optical element, for example an ophthalmic lens, to a communication network, in which an identifier is assigned to the optical element in order to route data via the network in accordance with said identifier.

### TECHNICAL FIELD OF THE INVENTION

The present invention belongs to the field of optical elements. It relates in particular to an optical element, such as an ophthalmic lens, to which is assigned an identifier in a communications network so that instructions to and/or from the lens can be routed in the network.

### PRIOR ART

Numerous functions are attached to optical elements. In particular, correction functionalities, solar protection or anti-debris functionalities, decorative or other functionalities are conventionally attached to optical elements.

However, the parameters for implementing these functionalities are invariant, or very difficult to modify. For example, when a wearer of a pair of sunglasses enters a tunnel, the degree of opacity of the lenses is no longer adapted to the environment of the wearer.

A need therefore exists to contextualize the functionalities related to optical elements.

### SUMMARY OF THE INVENTION

The present invention intends to improve the situation.

For this purpose, a first aspect of the invention relates to a method for connecting an optical element, for example an ophthalmic lens, to a communication network, in which an identifier is allocated to the optical element so as to route data via the network as a function of said identifier.

By “optical element” is meant any optical device intended to be placed in, on, close to, substantially facing or upstream of an organ of vision, such as an eye, in the direction of a light ray generated by a luminous source. In a nonlimiting application, the optical element is an ophthalmic lens mounted on a device, such as a pair of spectacles, intended for a human person. In a nonlimiting manner, the optical element can also be a telescope lens or microscope lens, an aircraft porthole, glass panes of a building, an intraocular implant, an ophthalmic contact lens, a windshield or car rear view mirrors or else the lens of a camera.

For example, such an optical element may have a corrective effect (sight spectacles) or may not (so-called “plain” lenses). The optical element can be opacifying (sunglasses), informative (information display) or else not exhibit any effect (decorative or protective spectacles).

By “communication network” is meant a set of equipment linked together to exchange information. The choice of the network is typically dependent on the technical constraints imposed on the network.

Thus, for a short-range radio link (typically less than 10 meters), a network of Bluetooth® type (and in particular the “Low energy” version 4.1) or ZigBee® type may for example be used. For a medium-range radio link (typically less than 100 meters), a network of wifi type or a home-automation oriented network, such as for example the Enocean® network of frequency 868 Mhz may for example be used. For a very-long-range radio link (typically greater than a kilometer), a ZigFox network may for example be used.

For a short-range optical link (typically able to cover the interior of a room), it will be possible for example to use a LiFi® network and for a very-short-range magnetic induction link a QI network.

Other protocols may be used, such as for example an IP, Ethernet, TCP/UDP, Internet network, a network using a universal asynchronous transceiver, for example of UART (Universal Asynchronous Receiver Transmitter) type, a network relying on the http (Hyper Text Transfer Protocol) protocol, etc.

By “to route data” is meant the mechanism by which paths are selected in the network to carry the data from a sender to one or more recipients. In particular, the data carried to and from the optical element are oriented in the network by virtue of the identifier of the optical element.

Thus, the instructions can be received and sent on the optical element by using the communication network. Henceforth, the optical element is able to receive information and/or instructions which are able to modify for example parameters for implementing functionalities of the optical lens. The operation of the optical element can therefore take into account a context transmitted by way of the communication network. Furthermore, data can be acquired by the optical element and transmitted by virtue of the communication network.

In one embodiment, the method comprises the steps of:
sending of at least one instruction able to be executed by a processor, the instruction being sent by an electronic device connected to the communication network destined for a network communication interface linked to the optical element;
reception of the instruction by the network communication interface linked to the optical element.

Thus, any electronic device connected to the network can transmit instructions to the optical element. Electronic devices such as these can comprise a user interface, so that a user can easily fill in instructions. These devices can also comprise sensors which can generate in an autonomous manner, or in combination with other devices such as motherboard or processor, instructions.

In another embodiment, the optical element is linked to a processor and to a memory and the method furthermore comprises the steps of storage of the instruction received in the memory linked to the optical element and of execution of the instruction by the processor linked to the optical element. Thus, the optical element integrates the components for implementing the instructions, which, at the industrial level, facilitates the integration of such optical elements.

In one embodiment, the instruction is able to be executed by the processor for the activation of a functionality for example for the activation of a functionality related to the optical element, for the activation of a functionality related to an electronic device connectable to the network or for the activation of a functionality related to a device connectable to the optical element. The optical element can therefore be a recipient of the instructions or simply relay these instructions to another device.

In another embodiment, the optical element is an ophthalmic lens of electroactive type. In this embodiment, the activation of the functionality related to the lens comprises a modification of at least one characteristic of an electroactive cell included in the lens.

By “electroactive lens” is meant any optical device for which at least one characteristic varies under the influence of an electrical and/or electromagnetic signal. Typically, a variation of the amplitude of an electrical signal applied to an electroactive lens modifies a characteristic of this lens.

A lens whose corrective power depends on an electrical signal, for which visual information is provided to the wearer (for example via a screen or a luminous source integrated with the lens), possessing active combiners (such as defined in patent application EP15306097) or else integrating luminous sources for a luminotherapy treatment are examples of electroactive lenses.

By “electroactive cell” is meant the means used to vary at least one characteristic of the lens as a function of an electrical signal.

Thus, the characteristics of the lens are adapted to the instructions received in the network. Henceforth, the lens advantageously adapts to its environment (in the case where the instructions originate from a sensor) or to the demands of a user.

In one embodiment, the method furthermore comprises, the steps of acquisition of a measurement by a sensor and of determination of the instruction on the basis of the measurement acquired by the sensor. The instructions are therefore rendered dependent on factors relating to the environment of the lens, thus increasing the relevance of the instructions generated. In particular, slaving the instructions to the measurement enables a direct and adapted response of the optical element.

In another embodiment, the measurement comprises at least one element from among a proximity measurement, a geolocation measurement, an acceleration measurement, a gyroscopic measurement, a pressure measurement, a temperature measurement, a measurement of tracking of a movement of at least one eye, a telemetry measurement, an audio signal, a video signal, a measurement of luminous intensity, in at least one frequency band of the electromagnetic spectrum. The proximity measurement can be acquired between the optical element and a user of the optical element, between the optical element and an external terminal (for example between a pair of spectacles and a smartphone connected to the optical element constituting the lenses of the pair of spectacles), between one optical element and another optical element, etc.

The geolocation measurement can correspond to at least one element from among a geographical location (for example via a latitude and a longitude), a position in space (for example in a Galilean frame of reference), a measurement of proximity with respect to another object, etc.

Taking these measurements into account individually or in combination improves the relevance of the instructions transmitted to the optical element. The comfort afforded by the optical element is therefore substantially improved, the characteristics of the optical element being adapted to the user of this optical element.

In one embodiment, the instruction is determined on the basis of an item of information collected by a collection device. Such a collection device is able to collect an electrical energy, for example acquired via a solar sensor (photovoltaic cell) or a sensor of a thermal or mechanical energy. This thermal or mechanical energy sensor can, for example and in a nonlimiting manner, be able to sense the energy generated at face level (body heat, eyelid flickering, movement of the mouth, micro-movements of the face, micro-currents of the skin . . . ). By “measurement” is meant, hereinafter, any item of information acquired by the measurement sensor and/or the collection device.

In one embodiment, the sensor is included in at least one element from among a terminal connected to the communication network, the optical element, a pair of spectacles comprising a frame on which the optical element is mounted, a frame of a pair of spectacles on which the optical element is integrated. Thus, the optical element benefits from or causes benefit from instructions adapted to the measurements made by various sensors.

In another embodiment, a terminal is connected to the communication network, the terminal furthermore being connected to a data network. In this embodiment, the method furthermore comprises the steps of:
acquisition by the terminal via the data network of an item of information relating to an environment of at least one element from among the optical element, a terminal, a user of the optical element and/or of the terminal;
determination of the instruction on the basis of the item of information.

By “data network” is meant any type of network able to provide data complementary to the data of the communication network. In one embodiment, the data network is distinct from the communication network. In particular, when the communication network is a local area network (for example bluetooth), the data network may for example be a wide area network (for example Internet via a 4G connection).

The item of information relating to the environment is typically a context item of information available on the data network (for example Internet) such as an item of information relating to the weather, to a map (topographical data), to an item of news, etc.

The means available at the level of the terminal are thus advantageously used to improve the relevance of the instructions transmitted to the optical element.

In one embodiment, the data are encrypted. Typically, an encryption of AES (Advanced Encryption Standard) and/or RSA type can be used to encrypt the data. The communications can also be encrypted, for example via https (HyperText Transfer Protocol Secure) or WPA (Wi-Fi Protected Access), to secure these data.

In another embodiment, the optical element is an electrochromic lens. By “electrochromic lens” is meant a lens, at least one color of which can be modified as a function of an electrical signal.

In one embodiment, the method comprises the step of sending of at least one message by a communication interface linked to the optical element destined for an electronic device connected to the communication network.

A second aspect of the invention relates to a computer program comprising instructions for the implementation of the method according to the first aspect of the invention, when these instructions are executed by a processor.

A third aspect of the invention relates to an optical element, such as an ophthalmic lens, able to be connected to a communication network, and comprising a memory adapted to store an identifier allocated to the optical element so as to route data via the network as a function of said identifier.

In one embodiment of the third aspect of the invention, the optical element is linked to a communication interface able to receive an instruction dispatched by an electronic device connected to the communication network. In this embodiment, the optical element furthermore comprises a processor able to execute the instruction.

A fourth aspect of the invention relates to a system comprising:
an optical element according to the third aspect of the invention;
a terminal comprising a sensor and connected to the communication network, the terminal furthermore comprising a processor adapted to perform the following operations:
   reception of a measurement acquired by the sensor;
   determination, on the basis of the measurement acquired by the sensor included in the terminal, of an instruction destined for the optical element.

A fifth aspect of the invention relates to an ophthalmic device intended to be worn by a user, comprising:
at least one optical element according to the third aspect of the invention;
a sensor;
a processor adapted to perform the following operations:
   reception of a measurement acquired by the sensor;
   determination of an instruction on the basis of the measurement acquired by the sensor.

### BRIEF DESCRIPTION OF THE DRAWINGS

Other characteristics and advantages of the invention will become apparent on examining the description detailed hereinafter and the appended drawings in which:

FIG. 1 illustrates a connected optical element, according to one embodiment of the invention;

FIG. 2A illustrates a possible environment for the optical element, according to a first embodiment of the invention;

FIG. 2B illustrates a possible environment for the optical element, according to a second embodiment of the invention;

FIG. 2C illustrates a possible environment for the optical element, according to a third embodiment of the invention;

FIG. 3 is a chart illustrating the steps of a method for connecting an optical element, according to one embodiment of the invention;

FIG. 4 illustrates a hardware architecture of devices according to the invention, in one embodiment.

### DETAILED DESCRIPTION

The invention is described hereinafter in its, nonlimiting, application to an optical element which is an ophthalmic lens included on a pair of spectacles.

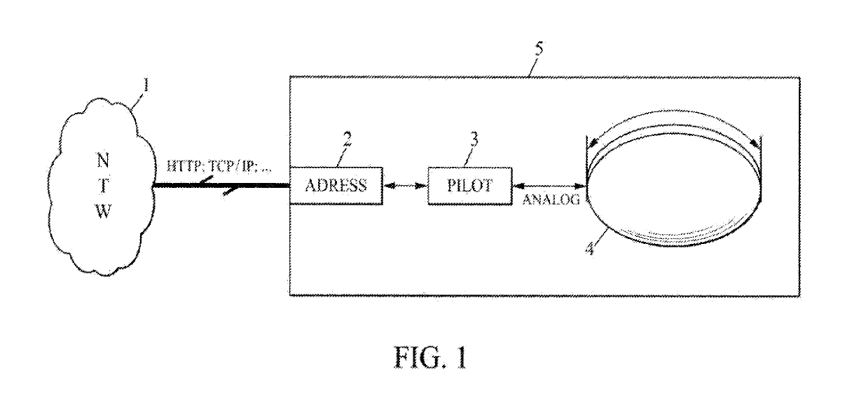

FIG. 1 thus illustrates a lens 5 connected to a communication network 1. In FIG. 1 et seq., the communication channel between the lens and the network 1 is represented by a thick line above which is mentioned examples of protocols (http; TCP/IP; . . . ) that can be used to carry the data in this communication channel.

An identifier is allocated to the lens 5 to route data via the network as a function of said identifier. According to the type of network used, and therefore according to the protocol associated with this type of network, the identifier can be of various natures. Thus, for an IP network, the identifier is an IP address, an MAC (Media Access Control) address, for an Ethernet network, etc.

The lens 5 comprises a drive circuit 3 for piloting an electroactive cell 4 and a communication interface 2 able to communicate with an electronic device connected to the communication network. The communication interface and/or the drive circuit can be simply linked (for example via a wired or wireless link) to the lens 5. The interface and/or the circuit can also be inlaid, glued or else molded in the lens 5.

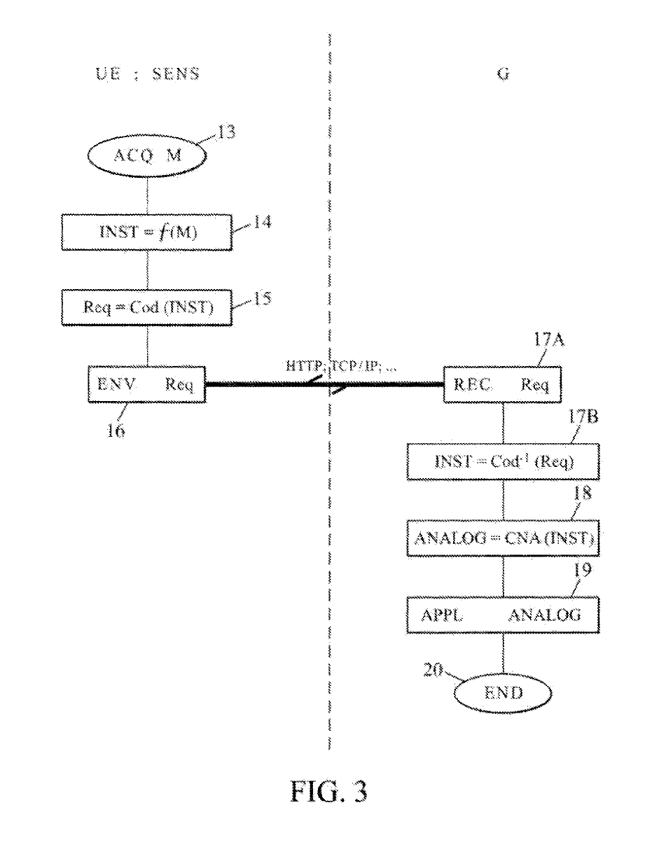

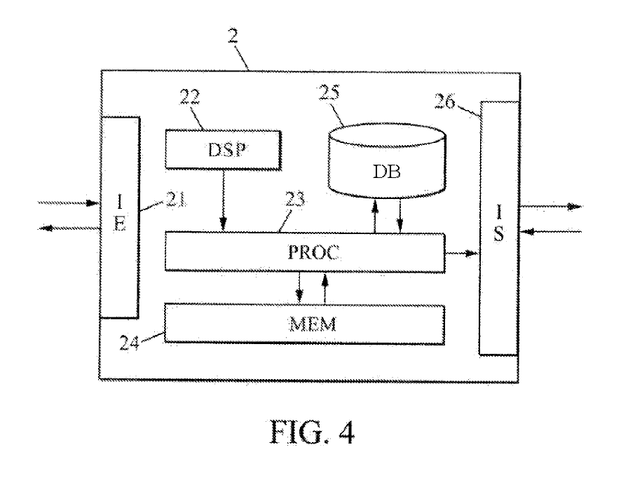

An example of the manner of operation and detail of the hardware architecture of the communication interface and of the drive circuit 3 are given respectively in FIGS. 3 and 4.

The electroactive cell 4 comprises means able to modify at least one characteristic of the lens by the application of an electrical, for example analog, signal (represented by the double arrow ANALOG in FIG. 1).

The electroactive cell can thus vary the corrective power of the lens, provide visual information to the wearer of the lens (typically when a screen is integrated with the lens), give instructions to active combiners, activate luminous sources, vary a degree of opacity or of transmission (ability or inability of the lens to transmit a light beam) of the lens, vary an electrical consumption of the lens, etc.

A lens whose corrective power depends on an electrical signal, possessing active combiners (such as are defined in patent application EP15306097) or else integrating luminous sources for a luminotherapy treatment are other examples of electroactive lenses, at least one of whose characteristics can be modified by an electroactive cell.

In particular, the lens can comprise display means able to display a visual item of information on the lens. For example, a screen, an active combiner able to generate a hologram, or at least one luminous source can be integrated with the lens.

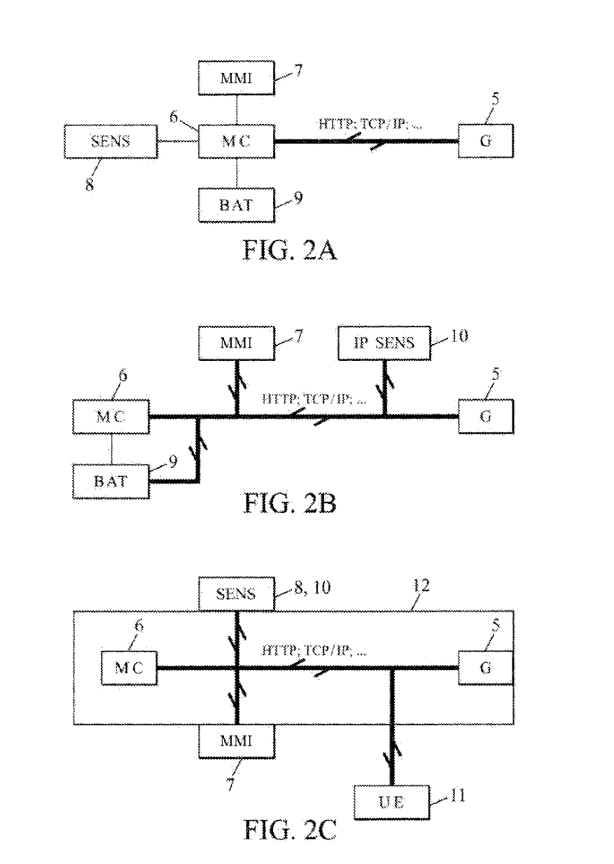

The network 1 consists of a plurality of electronic devices. Examples of arrangement of electronic devices linked to the lens 5 via the network 1 are now given with reference to FIGS. 2A, 2B and 2C.

FIG. 2A schematically illustrates an arrangement of electronic devices, according to a first embodiment. In this first embodiment, at least one lens 5 is included on a pair of spectacles and linked to a sensor 8, a motherboard 6, a battery 9 and a man machine interface 7.

The collection or measurement sensor 8 is typically:
a proximity sensor operating for example via a measurement of send/receive time of an electromagnetic wave. The proximity measurement can be made between the lens 5 and a wearer of the pair of spectacles, between the optical element and an external terminal, between the lens 5 and another optical element, etc.
a sensor of a location measurement, for example a geolocation measurement: The geolocation measurement can correspond to at least one element from among a geographical location (for example via a latitude and a longitude), a position in space (for example in a Galilean frame of reference), a measurement of proximity with respect to another object, etc. Such a sensor is typically a GPS (global positioning system) device, an inclinometer, a gyroscope, a telemeter, an accelerometer, etc.
an inclinometer for the acquisition of an inclination measurement;
a gyroscope for the acquisition of a gyroscopic measurement;
a telemeter for the acquisition of a distance measurement;
a manometer for the acquisition of a pressure measurement;
a thermometer for the acquisition of a temperature measurement;
an “eye tracker” device (device for tracking the movement of the eye) able to acquire a measurement for tracking a movement of at least one eye of the wearer of the pair of spectacles;
a microphone for the acquisition of a sound signal;
a camera for the acquisition of a video signal;
a sensor of a measurement of luminous intensity, in at least one frequency band of the electromagnetic spectrum;
a collection device able to collect an electrical energy, for example acquired via a solar sensor (photovoltaic cell) or a sensor of a mechanical energy (sensor of vibrations, for example on a face), a thermal energy, etc.

By “measurement” is meant hereinafter any item of information acquired by the measurement sensor and/or the collection device.

The man machine interface 7 comprises a means able to interact with a user of the lens 5, such as the wearer of the pair of spectacles. For example, this may be a matter of a simple breaker to activate or deactivate the electroactive functions of the lens 5, or of a touchpad, of a gestural interface, of an interface driven by brain wave or by the gaze or the voice.

The battery 9 is a device making it possible to energize the components 8, 7, 6 and the lens 5. The battery 9 may for example be of Lithium/ion or else Nickel/Cadmium type.

The battery 9 can also be integrated with the lens 5. In this situation, the lens 5 can comprise energy collection and/or distribution means, such as photovoltaic cells or thermal sensors. This may exhibit particular interest in the case where at least two lenses are connected together via the network 1 and when one of the lenses exhibits greater consumption than the other. In this situation, the lens exhibiting the largest consumption will be able to request and obtain extra energy from the battery integrated with the lens exhibiting lower consumption.

In this first embodiment, the motherboard 6 links the components 7, 8, 9 with the lens 5. The motherboard 6 therefore centralizes the management of the functions undertaken by the components 7, 8, 9 and comprises a communication interface able to send and/or receive data to and/or from the lens 5, via the network 1.

The communications made between the components 7, 8, 9 and the motherboard 6 are typically ensured by low-level protocols, such as Ethernet, ISDN (Integrated Services Digital Network), HomeRF, IEEE 1394 (FireWire), Thunderbolt, Wireless USB, Bluetooth, Wi-Fi, etc.

In a second embodiment, certain components can communicate directly with one another and with the lens 5 via the network 1. Thus, in FIG. 2B, an IP sensor 10 acquires data and is able to code these data as IP packets so as to transmit them to the other devices connected to the network 1. The lens 5 can thus access the data of the IP sensor 10 directly without going via the motherboard thereby making it possible to simplify the electronic architecture, and in particular the motherboard which no longer manages the IP sensor 10.

In a third embodiment, here described with reference to FIG. 2C, the pair of spectacles (referenced 12 in FIG. 2C) is connected via the network 1 to an external terminal 11. The link between the terminal 11 and the pair of spectacles 12 may be wired, wireless, optical, induction based, etc. In FIG. 2C is represented a connection according to one and the same protocol between the components of the spectacles 12 and the terminal 11. As a variant, different protocols can be used according to the links.

The terminal 11 can be a smartphone, a digital tablet, a connected watch, an office computer or a laptop computer, a terminal integrated into an automotive vehicle or into a GPS, a dedicated terminal used for the manufacture and/or the configuration of ophthalmic lenses, another pair of spectacles comprising connected lenses or any type of electronic device able to be connected to the network 1. The terminal 11 can comprise a sensor, such as described hereinabove in respect of the references 8 and 10.

The sensor, such as described hereinabove in respect of the references 8 and 10, can also be integrated directly into the lens 5. In this situation, data can be sent by the lens 5 destined for electronic devices connected to the network 1. In particular, several lenses according to the invention can thus communicate with one another.

A method for connecting the lens 5 to the network 1, according to one embodiment of the invention, is now described with reference to FIG. 3.

A datum M is firstly acquired in a step 13. This datum can correspond to a measurement acquired by the sensors 8 and/or 10 or by a sensor included on the terminal 11 or included on a connected lens of another pair of spectacles, to a preference indicated by a user via the man machine interface 7, to a predetermined condition stored on a memory of one of the components 5, 6, 7, 8, 9, 10 and/or 11 or to any request able to be transmitted by any type of device connected to the lens 5.

The datum M can thereafter be processed in a step 14 so that an instruction INST that is interpretable (for example executable by a processor able to allow the activation of a functionality related to the optical element) by the lens 5 is generated. A function ƒ can be applied to the datum M to generate this instruction INST. A non-exhaustive list of the instructions (also called requests, subsequent to a shaping step 15 described hereinafter) that can be generated is given hereinafter.

In a first non-limiting application of the present invention, a measurement of proximity between the pair of spectacles 12 and a smartphone 11 is used by the function ƒ to generate a variation instruction for varying the transmission of the lens 5. Thus, if an electrochromic lens is activated in the tinted state and if the wearer of the pair of spectacles approaches the screen of the smartphone, for example to consult it, the system will be able to react by increasing the transmission of the lens 5 so that this wearer can continue to see the screen in good conditions.

In one embodiment, the terminal 11 is connected to the communication network 1 and to a data network. In this embodiment, the terminal 11 acquires the measurement M via the data network, for example a 4G network.

In a non-limiting application of this embodiment, a geolocation measurement is performed by a sensor of the terminal 11 and/or lens 5. This measurement is then combined with a topographical item of information obtained by the data network to determine whether the terminal 11 and/or the lens 5 (for example via a measurement of proximity between the lens 5 and terminal 11) is situated in a tunnel. If so, an instruction is dispatched to the lens 5 so that this lens 5 becomes clear. On the contrary, if with the aid of the data network, it is determined that the terminal 11 and/or the lens 5 is entering a zone of significant illumination (weather data acquired on the Internet, typically), an instruction to opacify the lens 5 may be dispatched.

As a variant, the instruction acquired in step 13 is already interpretable by the lens 5.

In a step 15, the instruction INST is shaped so as to be able to be transmitted to the lens 5 via the network 1 in the shape of at least one request Req. This shaping step depends on the type of protocol used for the communications within the network 1.

Described hereinabove is an embodiment in which data are dispatched to the lens 5 from a device connected to the network 1. The present invention also covers the case where the lens 5 sends data destined for a device connected to the network 1. The case of the sending of data from the lens 5 can be deduced directly from the case of the receiving of data by the lens 5.

For example, the battery 9 may be a wireless QI charger. In this situation, the lens 5 communicates permanently with the battery 9 to indicate to it the electrical power which it needs in order to operate. Thus, in this situation, it is indeed the lens 5 which sends requests destined for an electronic device connected to the network 1.

A non-exhaustive list of data (requests in particular) that can be processed so as to be sent to or from the lens 5 is given hereinafter.

Command Requests for Controlling the Electroactive Function:
command to turn on/turn off the lens 5,
command a transmission level, with dispatching of the desired transmission level,
command to take into account a luminous flux received by the lens 5 so as to change the transmission, with dispatching of the luminous flux level as a function of the transmission adopted,
selection of a law determining a transmission as a function of a luminous flux from among several laws, with dispatching of the index number of the law to be used,
taking of control over the cell by an exterior system/control yielded to the motherboard.

Requests Related to the Parametrization of the Electroactive Lens:
parametrization of the min-max transmission ranges,
parametrization on the number and the value of transmission tiers, in the case when transmission tiers are used
parametrization on a speed of transition between two transmission levels,
parametrization on a transmission law as a function of a luminous flux,
parametrization of the cell piloting cycles.

Lens Interrogation Requests:
recovery of characteristics of the lens (color, transmission range, curvature of the cell, shape of the cell, materials of shells forming the cell, date of manufacture, etc.)
recovery of usage data: number of operating hours, current consumption, statistics on the transmission levels used, statistics on the dynamics of change of transmission, etc.

Miscellaneous Requests:
possibility of storing in the lens personal data such as data relating to the manufacture of the lenses, passwords, wearer supervision data such as data of a medical character (pulse, blood sugar levels, etc.), etc.

These data are preferentially encrypted (encryption by AES/RSA) so as not to be accessible to a third-party. The communications between the devices of the network 1 can also be encrypted (for example via https, WPA) to secure these data.

Other requests can also be dispatched, relating not only to the lens but also to the remainder of the frame of the pair of spectacles:

Request on the Frame:
recovery of the level of the battery 9,
parametrization of the management of energy and/or consumption of the lens as a function of the battery,
recovery of the data acquired by the sensor 8 or 10.

The electroactive lens can also dispatch requests to the various electronic devices connected to the network (in the frame or external to the frame):
request dispatched to the sensors of the frame,
request dispatched to the motherboard/battery to determine the charge level,
request dispatched to the terminal 11, for example to determine the position of the frame by a GPS of the terminal 11.

The request Req is thereafter dispatched to the lens 5 in a step 16. In one embodiment, the request Req is dispatched at specific instants. Typically, to optimize the energy consumption of the battery 9, provision may be made for the transmissions of data in the network 1 to be activated only periodically. For example, the network can be activated only every hour.

The transmission means of the electronic devices connected to the network 1 can also be made operational as a function of a charge level of the battery 9. For example, these transmission means can be activated only when the battery 9 is on charge or when it exhibits a charge level greater than a predetermined percentage, such as 75 percent for example. In the same manner, the making operational of at least one component included in at least one electronic device can also depend on a charge level of the battery 9.

The operation of the battery 9 can be slaved to the measurement acquired by the sensor and/or the collection device.

The request Req is received by the communication interface 2 in a step 17A and then decoded (steps symmetric to those applied during the shaping 15) into the instruction INST, still by the communication interface 2, in a step 17B.

In a step 18, a processing is applied by the drive circuit 3 to the instruction INST. This processing comprises for example a step of Digital-Analog Conversion, DAC, of the instruction INST into an analog signal ANALOG.

In a step 19, this signal ANALOG is then dispatched to the electroactive cell 4 so that the instruction INST is executed by the electroactive cell 4. The method terminates thereafter in a step 20.

An embodiment has been described in which measurements were acquired by a sensor before being processed (step 14 hereinabove for example) to generate an instruction subsequently dispatched to the lens 5. Provision may also be made for an instruction to be dispatched by a device connected to the network 1 and then for a measurement to be acquired by a sensor included on the lens 5 so as to weight, modify and/or adapt the instruction received by the lens 5.

FIG. 4 represents an exemplary hardware architecture for the communication interface 2, the drive circuit 3, the sensor 8, the IP sensor 10, the motherboard 6, the man machine interface 7, the lens 5, the battery 9 and/or the terminal 11. More generally, such an architecture can be used by any type of device to perform one at least of the steps of the method according to the invention.

As mentioned hereinabove with reference to FIG. 1, the communication interface 2 and/or the drive circuit 3 can be integrated directly into the lens 5 or simply linked to the lens 5 by any type of link. The communication interface 2 and/or the drive device 3 can take the form of a package comprising printed circuits, of a chip integrated (for example by gluing, molding, overprinting, etc) with the lens 5, of a computer, or else of any type of object able to communicate with the lens 5.

The hardware architecture of the communication interface 2 included in the lens 5 is described hereinafter by way of non-limiting example.

The communication interface 2 comprises a random-access memory 24 to store instructions for the implementation by a processor 23 of the method such as described hereinabove. In the case of the drive device 3, the processor is in particular able to execute the instruction received by the lens 5. The device can also comprise a mass memory 25 for storing data which are intended to be preserved after the implementation of the method.

The communication interface 2 can furthermore comprise a digital signal processor (DSP) 22. This DSP 22 receives the requests Req to demultiplex, demodulate and amplify, in a manner known per se, these requests, as is explained hereinabove with reference to step 17B of FIG. 3. The device also comprises an input interface 21 for receiving the requests Req and an output interface 23 for transmitting the instruction INST destined for the drive device 3.

The hardware architecture of the other components, and in particular of the drive circuit 3, can be deduced directly from that of the communication interface 2. In particular, the digital-analog converter of the drive circuit 3 can be a function executed by the processor 23 and/or the DSP 22.

In one embodiment, the optical element, such as an ophthalmic lens, integrates a memory adapted to store an identifier in the network, a communication interface able to send and/or receive at least one instruction over the network and a processor able to execute the instruction received from the network, so as in particular to activate a functionality, for example, related to the optical element.

The present invention is not limited to the embodiments described hereinabove by way of examples; it extends to other variants.

Thus, an embodiment comprising a specific apportionment of the execution of steps 17A to 20 between the communication interface 2 and the drive circuit 3 was described hereinabove with reference to FIG. 3. Another apportionment of the execution of these steps between the communication interface 2 and the drive circuit 3 can also be envisaged. For example, step 17A can be executed by the interface 2 and all the other steps by the drive circuit 3. Moreover, the order of the steps can be modified and certain steps (in particular step 15) ignored.

Furthermore, an arrangement of the lens 5 has been described in which the lens 5 comprises the communication interface 2 and the drive circuit 3. Other arrangements may be envisaged. Thus, the communication interface 2 and the drive circuit 3 can be bundled as a single electronic device, for example as an SoC (system on chip).

The invention has been described hereinabove in respect of its application to an ophthalmic lens included on a pair of spectacles. Other applications, such as those mentioned hereinafter, are deduced directly from what has been described in respect of a pair of spectacles.

The invention can indeed be applied to very varied fields. Diverse applications such as for example an optical element for a pair of spectacles, for a telescope, for an aircraft porthole, glass panes of a building, a windshield or car rear view mirrors or else for the lens of a camera are in particular covered by the present invention.

In particular, a car windshield can advantageously be connected to a communication network and thus display information provided by the network and useful for the driver. Likewise, the glass panes of a building can be linked by a communication network to sensors of the luminous intensity outside the dwelling so as to vary a degree of opacity of the glass panes.

Another possible application of the present invention consists in connecting to a communication network lenses situated in a building, for example in an open work space. In open work spaces such as these, individual sub-spaces delimited by glass panes may exist. These glass panes may comprise information display means (for example a screen integrated into the glass pane). Thus, an individual situated in a first individual work sub-space can transmit, via the communication network, an item of information which may be displayed on the display means of at least one glass pane of a second individual work sub-space.

In this application, a battery can also be integrated with the lens. The lens can furthermore comprise energy collection means, such as photovoltaic cells, thermal sensors, etc. The energy collected may be stored (temporarily or otherwise) by the battery. Furthermore, the energy collected can serve to supply the lens and/or may be distributed destined for devices that are external to the lens and are able to be linked to the lens. Finally, the operation of the battery may be slaved to the measurements acquired by a sensor and/or a collection device (switching on and/or regulation of operation when a specific measurement is received, for example). The present example can apply to any other optical device such as for example a glazing.

1. A method for connecting an optical element, for example an ophthalmic lens, to a communication network,
in which an identifier is allocated to the optical element so as to route data via the network as a function of said identifier.

2. The method as claimed in claim 1, comprising the steps of:
sending of at least one instruction able to be executed by a processor, the instruction being sent by an electronic device connected to the communication network destined for a network communication interface linked to the optical element; and
reception of the instruction by the network communication interface linked to the optical element.

3. The method as claimed in claim 2, in which the optical element is linked to a processor and to a memory, the method furthermore comprising the steps of:
storage of the instruction received in the memory linked to the optical element; and
execution of the instruction by the processor linked to the optical element.

4. The method as claimed in claim 2, in which the instruction is able to be executed by the processor for the activation of a functionality related to the optical element, for the activation of a functionality related to an electronic device connectable to the network or for the activation of a functionality related to a device connectable to the optical element.

5. The method as claimed in claim 2, in which the optical element is an ophthalmic lens of electroactive type, and in which the activation of the functionality related to the lens comprises a modification of at least one characteristic of an electroactive cell included in the lens.

6. The method as claimed in claim 2, in which the method furthermore comprises, the steps of:
acquisition of a measurement by a sensor; and
determination of the instruction on the basis of the measurement acquired by the sensor.

7. The method as claimed in claim 6, in which the measurement comprises at least one element from among:
a proximity measurement;
a geolocation measurement;
an acceleration measurement;
a gyroscopic measurement;
a pressure measurement;
a temperature measurement;
a measurement for tracking a movement of at least one eye;
a telemetry measurement;
an electrical energy;
an audio signal;
a video signal;
a measurement of luminous intensity, in at least one frequency band of the electromagnetic spectrum.

8. The method as claimed in claim 6, in which the sensor is included in at least one element from among:
a terminal connected to the communication network;
the optical element;
a pair of spectacles comprising a frame on which the optical element is mounted.

9. The method as claimed in claim 1, in which a terminal is connected to the communication network, the terminal furthermore being connected to a data network, the method furthermore comprising the steps of:
acquisition by the terminal via the data network of an item of information relating to an environment of at least one element from among the optical element, a terminal, a user of the optical element and/or of the terminal; and
determination of the instruction on the basis of the item of information.

10. The method as claimed in claim 1, in which the optical element is an electrochromic lens.

11. A non-transitory computer readable storage medium storing a computer-executable program comprising instructions for implementing the method according to claim 1.

12. An optical element, such as an ophthalmic lens, able to be connected to a communication network, comprising:
a memory adapted to store an identifier allocated to the optical element so as to route data via the network as a function of said identifier.

13. The optical element as claimed in claim 12, in which the optical element is linked to a communication interface able to receive an instruction dispatched by an electronic device connected to the communication network, and in which the optical element furthermore comprises:
a processor able to execute the instruction.

14. A system comprising:
an optical element as claimed in claim 12;
a terminal comprising a sensor and connected to the communication network, the terminal furthermore comprising a processor adapted to perform the following operations:
reception of a measurement acquired by the sensor; and
determination, on the basis of the measurement acquired by the sensor included in the terminal, of an instruction destined for the optical element.

15. An ophthalmic device intended to be worn by a user, comprising:
at least one optical element as claimed in claim 12;
a sensor;
a processor adapted to perform the following operations:
reception of a measurement acquired by the sensor; and
determination of an instruction on the basis of the measurement acquired by the sensor.
